(19) United States
(12) Patent Application Publication
(10) Pub. No.: US 2010/0255354 A1
(43) Pub. Date: Oct. 7, 2010

(54) Battery box assembly for toys

(76) Inventor: Shigetada Taya, Yokohama city (JP)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,406

(22) Filed: Nov. 29, 2007

(51) Int. Cl. H01M 2/12; H01M 2/10

(52) U.S. Cl. 429/82; 429/97

(57) ABSTRACT

A battery box assembly for toys includes a frame having an engaging portion on a side thereof and a box has a first end pivotably connected to the frame and a battery unit 3 is inserted into the box via an open end defined in a second end of the box. Two pivotable locking members are connected on two sides of the box and the battery unit has two protrusions which are removably engaged with the locking members. A hook member is pivotably connected to one of the two sides of the box and removably hooked to the engaging portion.

### FIELD OF THE INVENTION

The present invention relates to a battery box assembly for toys and includes two locking members for securing the battery and the battery can be easily removed by pushing the locking members.

### BACKGROUND OF THE INVENTION

FIG. 7 shows a battery box 71 for receiving a battery 73 for a remote control helicopter 6 wherein the battery box 71 is located at the head of the remote control helicopter 6 and the battery 73 is secured to the frame 71 by fastening belts 72. The fastening belts 72 might loose during severe operation of the remote control helicopter 6 and the battery 72 might drop and injures people. The fastening belts 72 have to be cut when replacing the battery 73 and this is inconvenient for the users.

The present invention intends to provide a battery box assembly for toys and the battery box assembly includes two pivotable locking members which secure the protrusions on two sides of the battery which can be easily removed from the battery box by pushing the locking members.

### SUMMARY OF THE INVENTION

The present invention relates to a battery box assembly for toys and comprises a frame having an engaging portion on a side thereof and a box has a first end thereof pivotably connected to the frame. An open end is defined in a second end of the box.

Two pivotable locking members are connected on two sides of the box. A battery unit is inserted into the box via the open end of the box and has two protrusions extending from two sides thereof so as to be engaged with the pivotable locking members. A hook member is pivotably connected to one of the two sides of the box and removably hooked to the engaging portion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the box and the battery unit of the present invention;

FIG. 2 is a side view to show that the battery unit is received in the box and positioned by the hook member;

FIG. 3 is a cross sectional view to show that the protrusions on the battery unit are engaged with the pivotable locking members on the box;

FIG. 4 is a cross sectional view to show that the protrusions on the battery unit are disengaged from the pivotable locking members on the box;

FIG. 5 shows that the hook member is unhooked and the battery unit is removed from the box;

FIG. 6 is a cross sectional view to show another embodiment of the protrusions on the battery unit and the pivotable locking members on the box, and

FIG. 7 shows a conventional battery box assembly.

### DETAILED DESCRIPTION OF THE PREFERRED EMBODIMENT

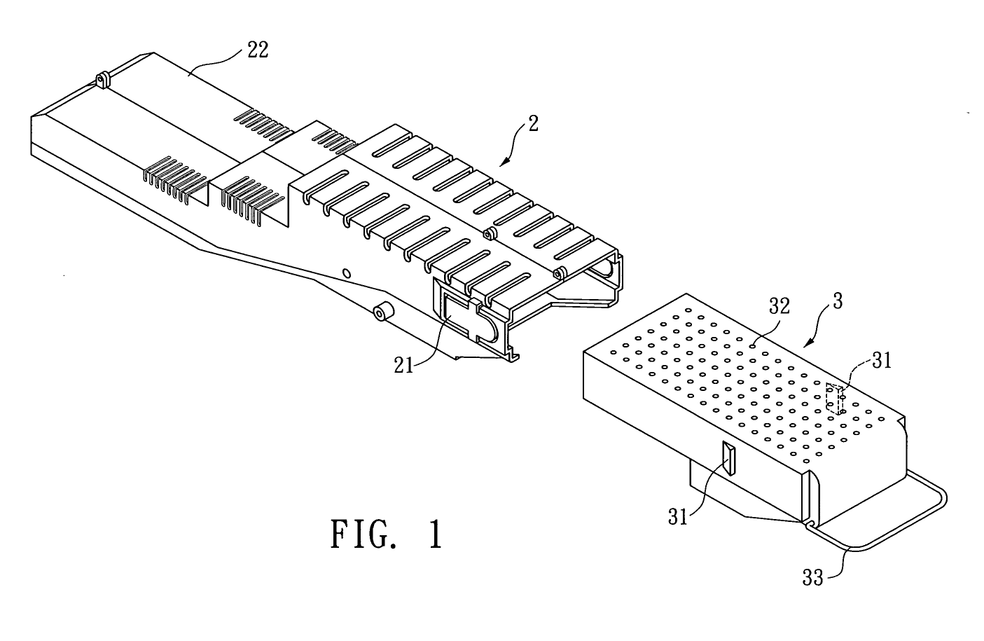

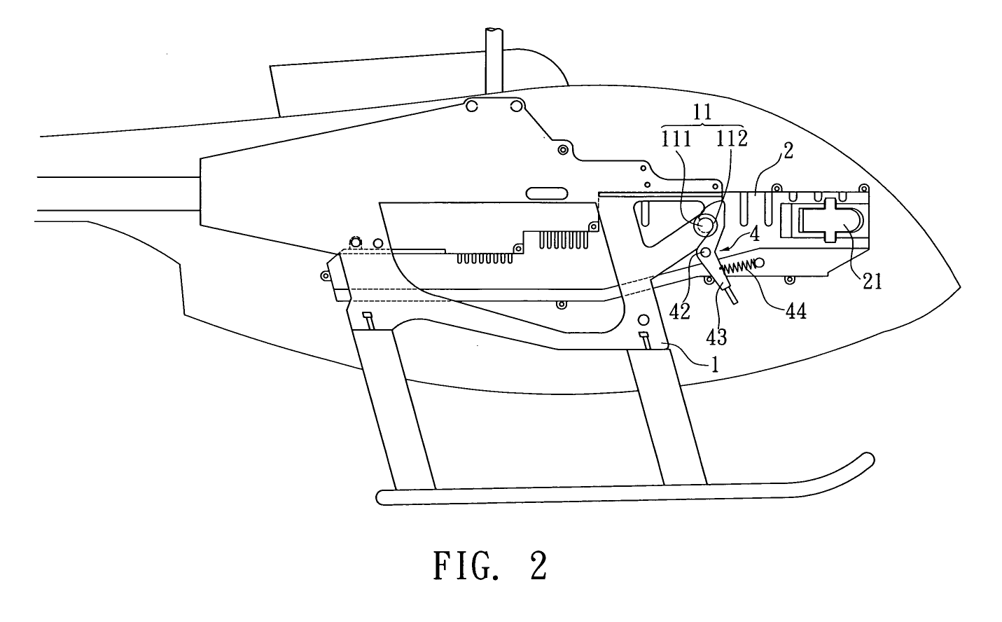

Referring to FIGS. 1 and 2, the battery box assembly for toys of the present invention comprises a frame 1 on the toy such as a remote control helicopter and includes an engaging portion 11 on a side of the frame 1. The engaging portion 11 includes a rod 111 and a disk 112.

A box 2 includes a first end pivotably connected to the frame 1 and an open end is defined in a second end of the box 2. Two pivotable locking members 21 are connected on two sides of the box 2. A circuit case 22 is connected to the first end of the box 2 so as to receive the circuit board, the electronic parts and the like.

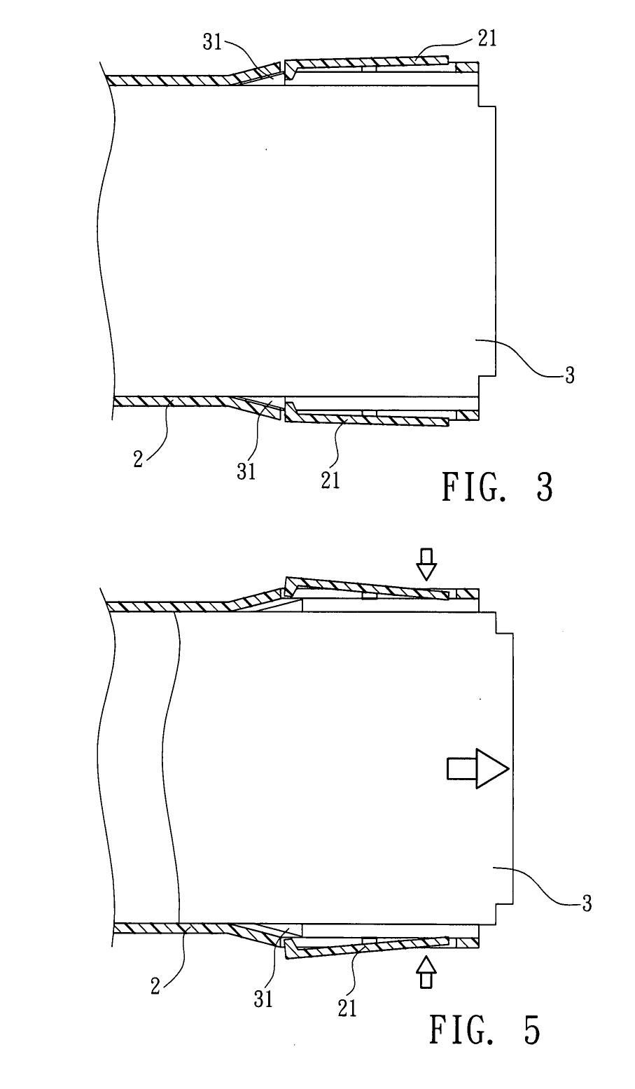

A battery unit 3 includes a plurality of ventilation holes 32 defined in a top thereof and a handle 33 is pivotably connected to an end of the battery unit 3. The battery unit 3 is inserted into the box 2 via the open end of the box 2 and includes two protrusions 31 extending from two sides thereof. The protrusions 31 each have an inclined surface as shown in FIG. 3 such that when the battery unit 3 is inserted into the box 2, the pivotable locking members 21 are pushed outward by the inclined surfaces and then the pivotable locking members 21 are pivoted to lock the protrusions 31 as shown in FIG. 3.

A hook member 4 includes a hook portion 41 and a lever 43, a hole 43 is defined between the hook portion 41 and the lever 43. A side rod extends from the frame 1 and is engaged with the hole 43 so that the hook member 4 is pivotably connected to the frame 1. A spring 44 is connected between the lever 43 and the box 2. The hook portion 41 is hooked to the rod 111 and located between the disk 112 and a side of the frame 1.

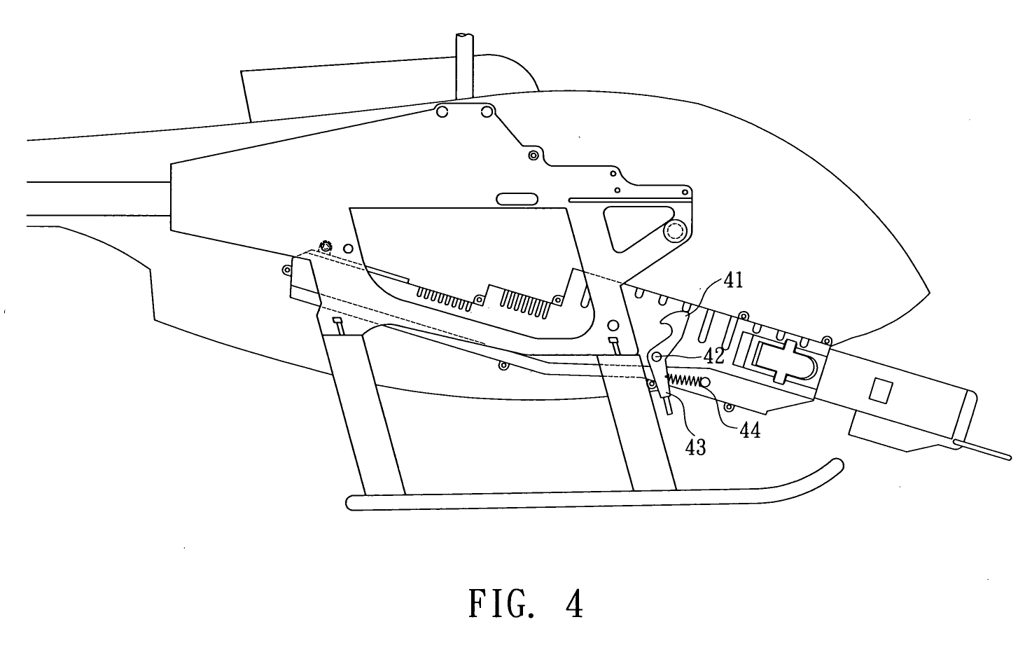

As shown in FIGS. 4 and 5, when replacing the battery unit 3, the lever 43 is pivoted and the hook portion 41 is unhooked from the rod 111. The box 2 is then pivoted to lower the second end thereof, the user then pushes the pivotable locking members 21 to allow the protrusions 31 to pass and the battery unit 3 can be easily removed from the box 2.

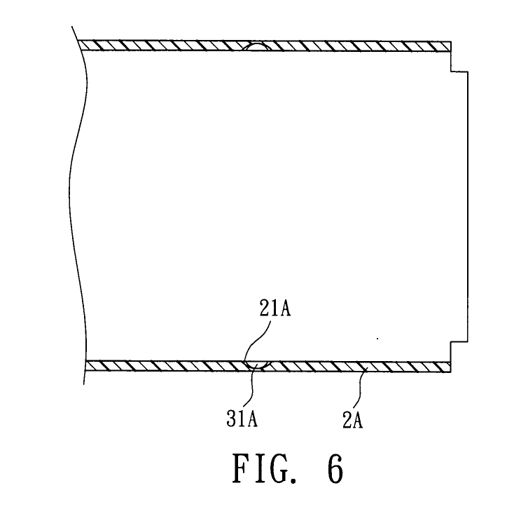

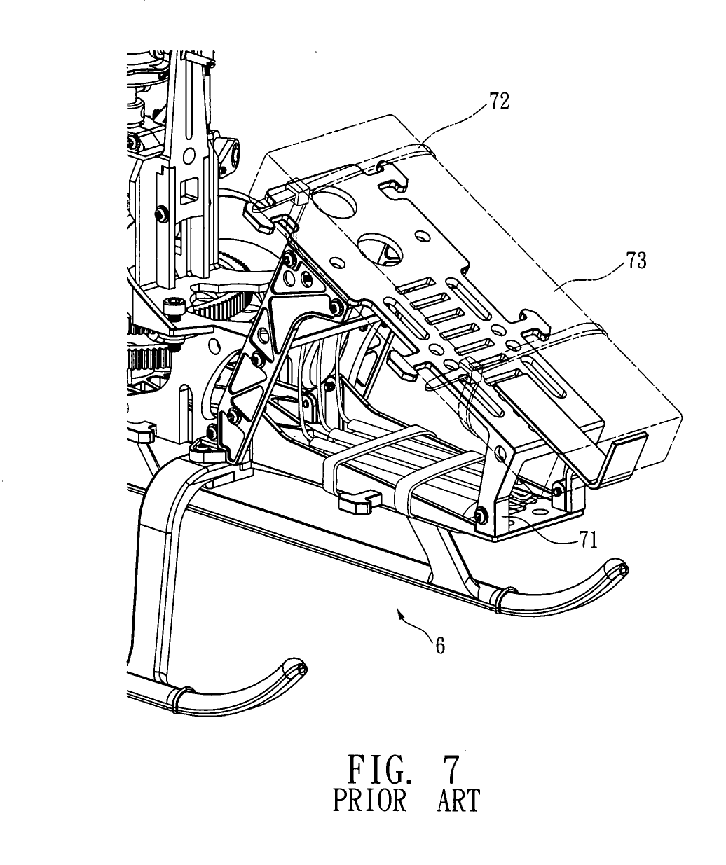

FIG. 6 shows another embodiment of the protrusions 31A on the battery unit and the pivotable locking members 21A on the box 2A, wherein the protrusions 31A of the battery unit are two bosses and the pivotable locking members 21A of the box 2A are two concavities with which the bosses are engaged.

While we have shown and described the embodiment in accordance with the present invention, it should be clear to those skilled in the art that further embodiments may be made without departing from the scope of the present invention.

What is claimed is:

1. A battery box assembly for toys, comprising:
a frame having an engaging portion on a side thereof;
a box having a first end pivotably connected to the frame and an open end defined in a second end of the box, two pivotable locking members connected on two sides of the box;
a battery unit inserted into the box via the open end of the box and having two protrusions extending from two sides thereof, the protrusions removably engaged with the pivotable locking members, and
a hook member pivotably connected to one of the two sides of the box and removably hooked to the engaging portion.

2. The assembly as claimed in claim 1, wherein the battery unit includes a plurality of ventilation holes defined in a top thereof and a handle is pivotably connected to an end of the battery unit.

3. The assembly as claimed in claim 1, wherein a circuit case is connected to the first end of the box.

4. The assembly as claimed in claim 1, wherein the engaging portion includes a rod and a disk, the hook member is hooked onto the rod and located between the disk and a side of the frame.

5. The assembly as claimed in claim 4, wherein the hook member includes a hook portion and a lever, a hole is defined between the hook portion and the lever, a side rod extends from the frame and engaged with the hole, the hook portion is hooked to the rod, a spring is connected between the lever and the box.

6. The assembly as claimed in claim 1, wherein the protrusions of the battery unit are two bosses and the pivotable locking members of the box are two concavities with which the bosses are engaged.
